(19) United States
(12) Patent Application Publication
(10) Pub. No.: US 2009/0245843 A1
(43) Pub. Date: Oct. 1, 2009

(54) Method of Controlling Belt Fixing Device, Belt Fixing Device, and Image Forming Apparatus

(75) Inventor: Makoto SATO, Matsumoto - shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/413,315

(22) Filed: Mar. 27, 2009

(30) Foreign Application Priority Data
Mar. 27, 2008 (JP) 2008-082294

(51) Int. Cl. G03G 15/20

(52) U.S. Cl. 399/69; 399/329

(57) ABSTRACT

A method of controlling a belt fixing device, in which a fixing belt is stretched between a fixing roller and a heating roller, includes detecting a temperature of the fixing belt at the time of stoppage. On the basis of the detection result, a driving unit is rotated forward or backward a predetermined number of times when the fixing belt having stopped is driven again.

### CROSS-REFERENCE TO RELATED APPLICATIONS

This application claims the benefit of priority under 35 USC 119 of Japanese patent application no. 2008-082294, filed on Mar. 27, 2008, which is incorporated herein by reference.

### BACKGROUND

1. Technical Field

The invention relates to a method of controlling a belt fixing device that can prevent an end portion of a belt from being damaged, and an image forming apparatus.

2. Related Art

Electrophotographic image forming apparatuses use a belt fixing device as a fixing device for a transfer medium. In such a belt fixing device, the belt is a thin endless belt that is manufactured by coating silicon rubber on a base material, such as stainless steel, nickel, or the like, and forming a heat-resistant release layer having good heat resistance and releasability against toner.

In the belt fixing device, preventing the fixing belt from being damaged is an issue. For example, Japanese Patent No. 3,711,717 discloses a configuration in which an abutting type ring against skewed movement of the fixing belt is provided at one axial end of a tension roller, which gives tension to a fixing roller. In this example, the amount of thermal expansion of the fixing belt is smaller than that of the tension roller (heating roller) on which the ring is provided.

In the configuration of Japanese Patent No. 3,711,717, during cooling, the amount of thermal contraction of the heating roller becomes larger than that of the fixing belt. Accordingly, a guide ring strongly presses the end portion of the fixing belt in an axial direction of the heating roller. Although the fixing belt is pressed in the axial direction of the heating roller by the guide ring, it cannot be easily “shifted” in the axial direction due to frictional force between the fixing belt and the heating roller. For this reason, a large stress is applied to the end portion of the fixing belt, and accordingly ruffles (wrinkles) may be formed in the fixing belt. When this happens, if the heating roller is driven again, two ruffles that are formed in the fixing belt are moved and connected to each other. As a result, in the worst case, the fixing belt may be damaged (cracked).

In order to reduce the frictional force between the fixing belt and the heating roller, it is effective to coat the heating roller with fluorine or to decrease tension of the fixing belt. However, in order to stably drive the fixing belt crept by fixing heat, predetermined tension needs to be applied, and the above-described measure has an insufficient effect.

### SUMMARY

The invention provides a method of controlling a belt fixing device that can prevent an end portion of a fixing belt from being damaged, a belt fixing device, and an image forming apparatus.

According to an aspect of the invention, a method of controlling a belt fixing device is provided in which a fixing belt is stretched between a fixing roller and a heating roller. The temperature of the fixing belt at the time of stoppage is detected, and on the basis of the detection result, a driving unit is rotated forward or backward a predetermined number of times when the fixing belt having stopped is driven again.

In the method of controlling a belt fixing device according to the aspect of the invention, the predetermined number of times of forward or backward rotation may be selected depending on one of a coefficient of static friction between the heating roller and the fixing belt, tension of the fixing belt, and an inversion velocity of the fixing belt at the time of forward or backward rotation.

In the method of controlling a belt fixing device according to the aspect of the invention, if an end portion bend length of the fixing belt when a unit preventing skewed movement of the fixing belt toward an axial end of the heating roller comes into contact with an end portion of the fixing belt and hooks the end portion of the fixing belt is x, then, a travel distance of the fixing belt in a rotation direction when the driving unit of the fixing belt rotates forward or backward may be set to be not more than 4x.

In the method of controlling a belt fixing device according to the aspect of the invention, when the temperature of the fixing belt at the time of stoppage reaches a predetermined temperature, or when a difference in between the temperature of the fixing belt at the time of stoppage and a temperature of the fixing belt immediately before being driven becomes a predetermined value, the driving unit of the fixing belt may be rotated forward or backward a predetermined number of times.

According to another aspect of the invention, a belt fixing device is provided that includes a fixing roller, a heating roller, a fixing belt stretched between the fixing roller and the heating roller, and a pressing roller pressing the fixing roller through the fixing belt. In at least one end portion of the heating roller in an axial direction, a ring regulating skewed movement of the fixing belt toward an axial end, and a temperature detection unit detecting a temperature of the fixing belt at the time of stoppage are provided. The temperature detected by the temperature detection unit is stored in a storage unit, and a control unit controls forward or backward rotation of a driving unit a predetermined number of times on the basis of the temperature of the fixing belt at the time of stoppage stored in the storage unit when the fixing belt is driven again.

In the belt fixing device according to another aspect of the invention, the temperature detection unit may detect a temperature of the fixing belt at the end of the operation and a temperature of the fixing belt immediately before being driven again, and may store the detection results in the storage unit.

According to yet another aspect of the invention, an image forming apparatus includes image forming units each having at least one of a charging unit, an exposure unit, a developing unit, and a transfer unit around a photosensitive member, and a belt fixing device, which is controlled by the control method according to the aspect of the invention. The image forming apparatus transfers an image formed on each of the image forming units to a recording medium, thereby performing image formation.

According to yet another aspect of the invention, an image forming apparatus is provided that includes image forming units each having at least one of a charging unit, an exposure unit, a developing unit, and a transfer unit around a photosensitive member, and the belt fixing device according to another aspect of the invention. The image forming apparatus transfers an image formed on each of the image forming units to a recording medium, thereby performing image formation.

### BRIEF DESCRIPTION OF THE DRAWINGS

The invention will be described with reference to the accompanying drawings, wherein like numbers reference like elements.

FIGS. 1A-1C are explanatory views illustrating a heating roller and a fixing belt according to an embodiment of the invention in a state before the fixing belt starts to be driven.

FIG. 2 is a magnified explanatory view of the heating roller and fixing belt of FIG. 1C.

FIG. 3 is an explanatory view illustrating a positional relationship between a guide ring and the fixing belt before and after thermal contraction.

FIG. 4 is an explanatory view of a belt fixing device according to an embodiment of the invention.

FIG. 5 is an explanatory view illustrating a fixing method of a heating roller and a fixing belt to a fixing unit in the belt fixing device.

FIG. 6 is an explanatory view illustrating a sensor provided to check the surface temperature distribution of the fixing belt in the belt fixing device.

FIG. 7 is an explanatory view illustrating lengths of the heating roller and fixing belt when being cooled.

FIG. 8 is a characteristic diagram illustrating the length of the heating roller when being heated.

FIG. 9 is an explanatory view of the belt fixing device.

FIG. 10 is an explanatory view of the belt fixing device.

FIG. 11 is a block diagram of a control device according to an embodiment of the invention.

FIG. 12 is side sectional view of an example of an image forming apparatus using an electrophotography process according to the invention.

### DESCRIPTION OF EXEMPLARY EMBODIMENTS

An embodiment of the invention is now described with reference to the drawings. FIG. 4 is an explanatory view illustrating an example of a belt fixing device 30. In FIG. 4, a fixing belt 34 is stretched between a fixing roller 31 and a heating roller 35, which function as belt tension rollers.

A fixing heater 36 is provided inside the heating roller 35. The temperature of the fixing belt 34 is detected by using a temperature detection device 37, such as a thermistor. The fixing heater 36 serving as a heat source is turned on/off on the basis of the detection result of the temperature detection device 37r to thereby perform temperature control of the heating roller 35 that should be maintained at a desired temperature. A halogen lamp may be used, for example, as the fixing heater 36. An overheating prevention device 38 is provided near the heating roller 35 to prevent fire when an abnormality is produced. The heating roller 35 is given a pressing force Ft by a belt tension spring 33a to apply tension to the fixing belt 34. The pressing roller 32 is given a pressing force Fp by a pressing spring 33.

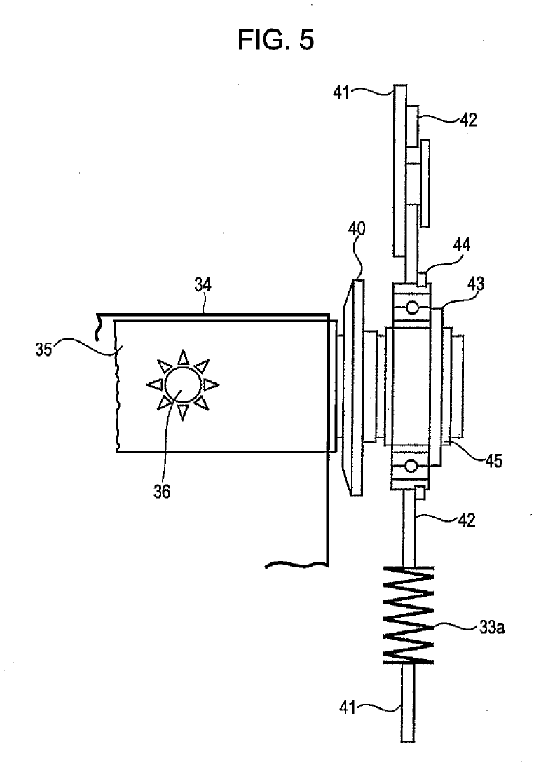

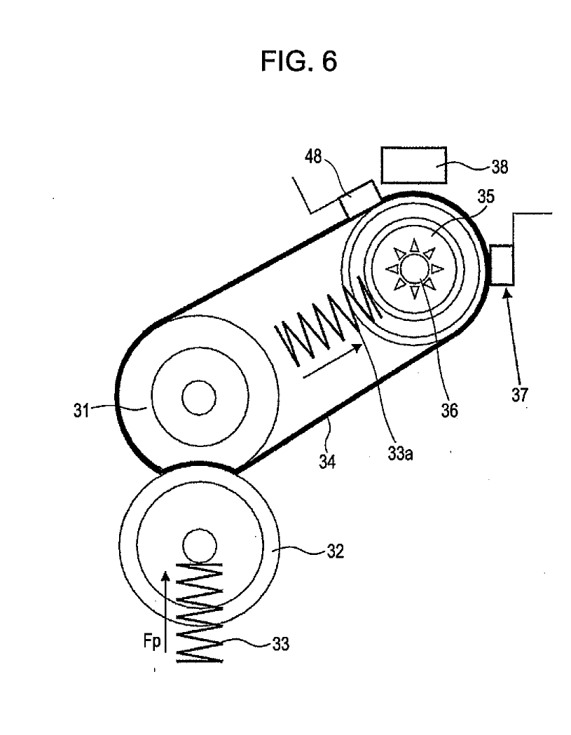

FIG. 5 is an explanatory view illustrating a fixing method of the heating roller 35 and the fixing belt 34 to a fixing unit in the belt fixing device. In FIG. 5, a bearing 44 fixing the heating roller 35 is inserted into a tension plate 42, and the tension plate 42 is fixed to be movable in one direction with respect to a fixing frame 41. The tension plate 42 is urged in one direction by the belt tension spring 33a, one end of which is fixed to the fixing frame 41. With this configuration, the fixing belt 34 is stretched between the heating roller 35 and the fixing roller 31 under substantially uniform tension.

The bearing 44 has sealed grease in terms of heat resistance, and since the surface temperature of the heating roller 35 reaches an extremely high temperature, it is inserted into a rotational shaft (flange) of the heating roller 35 through a heat-insulating bush 43. A guide ring 40 is rotatable and movable in a thrust direction in at least one end portion of the heating roller 35 toward the rotational shaft, that is, to be spaced from the rotational shaft of the heating roller 35. The guide ring 40 regulates skewed movement of the fixing belt 34 toward an axial end of the heating roller 35.

Members of the belt fixing device are now described in detail. As described with reference to FIG. 4, the fixing belt 34 is stretched between the fixing roller 31, which is positioned in the fixing unit, and the heating roller 35, which is urged to be movable in a predetermined direction by the belt tension spring 33a. In terms of the belt layout, an intermediate roller may be provided between the fixing roller 31 and the heating roller 35, and the fixing belt 34 may be stretched around three or more rollers.

The fixing roller 31 is configured to have a large heat capacity in order to ensure a nip width. A heat source is provided in the heating roller 35 having a small heat capacity and heat is transferred to the fixing roller 31 through the fixing belt 34, thereby reducing a warm-up time. In the example of FIG. 4, the heating roller 35 has the internal fixing heater 36 serving as a heat source, but an electromagnetic induction heating (IH) type heat source may be provided inside and outside the heating roller 35.

The pressing roller 32 is pressed against the fixing roller 31 by the pressing spring 33 with the fixing belt 34 sandwiched therebetween. The pressing roller 32 and the fixing roller 31 are formed of elastic members, and a nip is formed. In the example of FIG. 4, with respect to hardness of the members, the pressing roller 32 has a hardness larger than that of the fixing roller 31, and a downward nip is formed. In a high-speed machine, a heat source may be provided in the fixing roller 31 or the pressing roller 32. With respect to drive input, in many cases, the fixing roller 31 is connected to the outside through a gear or the like to function as a driving roller, but it may be connected to the pressing roller 32 and driven.

Materials of the members used for the belt fixing device are now described. In one embodiment of the invention, the fixing belt 34 is a three-layered belt in which an elastic layer made of silicon rubber is formed on an Ni electroformed member, and a release layer made of fluorine resin is further formed. In order to reduce the warm-up time, the heating roller 35 is provided separately from the fixing roller 31. For this reason, it is necessary to transfer heat from the heating roller 35 to the nip portion through the fixing belt 34, and as a base material of the fixing belt 34, a metal belt having a comparatively large heat capacity is used. This is because a resin belt made of polyimide or the like has a small heat capacity, and heat is dissipated to the nip portion, which causes a large heat loss.

The fixing belt 34 has a seamless metal belt, and as described above, Ni electroforming is applied. When a stainless belt from among the metal belts is used, it is necessary to reduce a curvature due to the hardness of the belt, and to increase the diameter of the roller and the size of the fixing device. The elastic layer of the fixing belt is provided in order to increase adhesion to an image surface and to ensure image quality. For the elastic layer, silicon rubber is used because of excellent heat resistance.

In the fixing belt 34, a release layer made of fluorine resin is provided in order to release toner molten in the nip portion from the surface of the belt. Perfluoroalkoxy alkane resin (PFA) is used as the material of the release layer. In the related art, as described in Japanese Patent No. 3,711,717, silicon oil is coated on an elastic layer made of silicon rubber to ensure releasability. However, since silicon oil is stuck to the sheet, writability deteriorates, and in recent years there has therefore been little use of silicon oil.

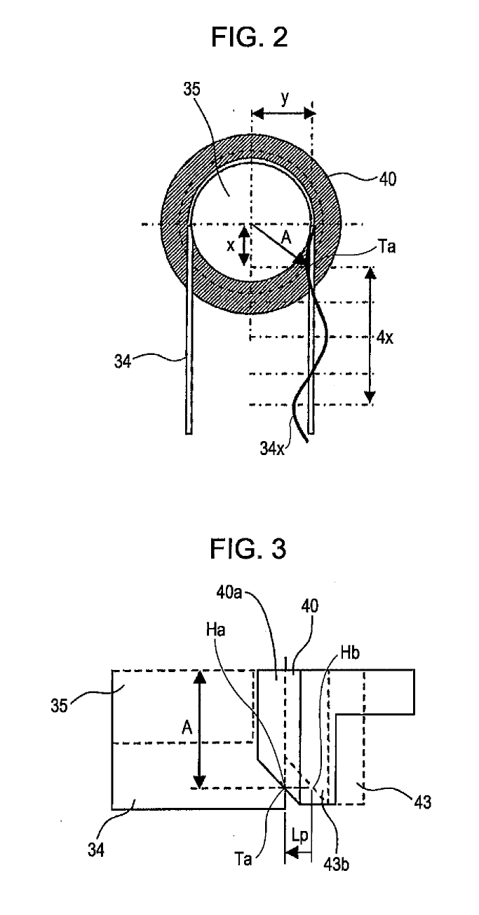

In order to reduce the warm-up time, a thin metal roller having a small heat capacity is used as the heating roller 35. For the thin metal roller, in order to make the temperature distribution in the axial direction uniform, aluminum having high thermal conductivity is used. In order to improve sheet releasability of the image surface, the fixing roller 31 forms a downward nip, as shown in FIG. 2, or a horizontal nip. As the fixing roller 31 that has hardness smaller than that of the pressing roller 32, a sponge roller or the like is used. As the pressing roller 32, in many cases, a rubber roller is used. In terms of heat resistance, for the pressing roller 32, silicon rubber is used. In order to prevent contamination of the rear surface of the sheet and to improve surface releasability, a fluorine resin layer is formed on the surface of the pressing roller 32.

In a normal state, the fixing belt 34 is conveyed between the fixing roller 31 and the heating roller 35 without being skewed in the axial direction of the roller. However, for example, when the two rollers (the fixing roller 31 and the heating roller 35) with the fixing belt 34 stretched therebetween is not in parallel, the fixing belt 34 is skewed in the axial direction of the roller. The skewed fixing belt 34 rotates at least one tension roller of the fixing roller 31 and the heating roller 35 backward, and the fixing belt 34 moves in an opposite direction to the forward rotation.

FIG. 6 is an explanatory view illustrating a sensor 48 that is provided to check the surface temperature distribution of the fixing belt 34 in belt fixing device 30. An operation to prevent the fixing belt 34 from being damaged due to thermal stress is performed on the basis of the surface temperature distribution of the fixing belt 34 at the time of stoppage checked by the sensor 48, as described below.

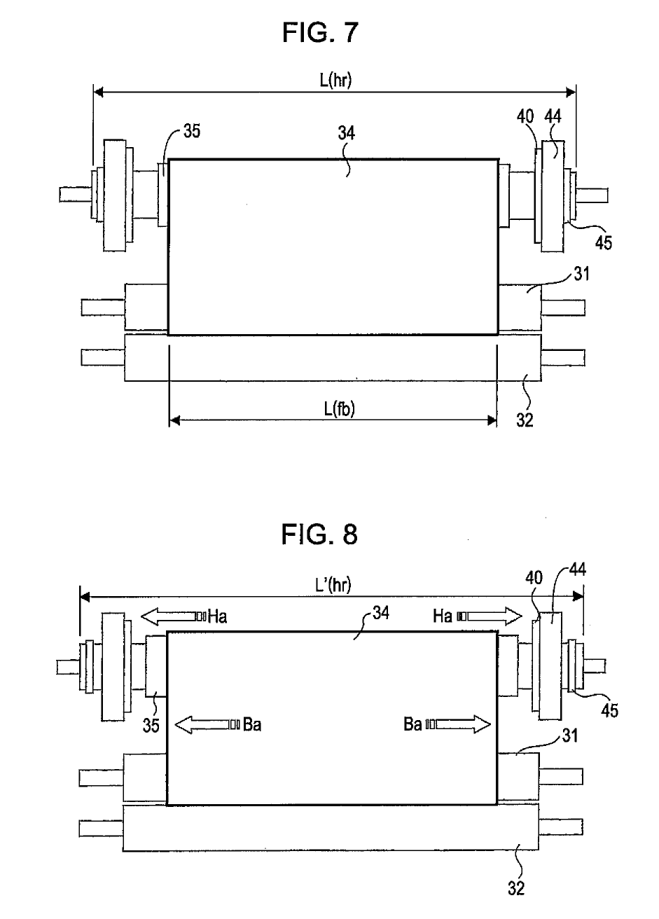

The stress that is applied to the end portion of the fixing belt 34 is now described with reference to FIGS. 7-10. FIG. 7 illustrates the length L(hr) of the heating roller 35 and the length L(fb) of the fixing belt 34 when being cooled. FIG. 8 illustrates the length L′(hr) of the heating roller 35 when being heated. In the configuration of FIGS. 7 and 8, aluminum having high thermal conductivity is used such that the temperature distribution of the heating roller 35 in the axial direction is made uniform when a small size of sheet passes. An Ni electroformed belt that is maintained at a temperature from a heated portion to the nip portion is used as the fixing belt 34.

If the heater is turned on, the heating roller 35 starts to expand. In FIG. 8, Ha and Ha represent thermal expansion toward both ends of the heating roller 35 in the axial direction. When the heating roller 35 reaches a target temperature, the heating roller 35 is extended by ΔL(hr), and thus the total length of the heating roller 35 is as follows.

L′(hr)=L(hr)+ΔL(hr)

The relationship of the extension amount according to a difference in linear expansion coefficient between the heating roller 35 and the fixing belt 34 will be described. In the embodiment of the invention, stress due to thermal contraction is generated when the following relationship is established with respect to the linear expansion coefficient. Heating Roller->Fixing Belt

As the heating roller 35 is heated, heat is transferred to the fixing belt 34 wound around the heating roller 35, and the fixing belt 34 starts to thermally expand. In FIG. 8, Ba and Ba represent thermal expansion of the fixing belt 34 toward both ends of the roller. When the fixing belt 34 reaches a target temperature, the fixing belt 34 is extended by ΔL(fb) due to thermal expansion, and thus the total length of the fixing belt 34 is as follows.

L′(fb)=L(fb)+ΔL(fb)

In the configuration of FIG. 8, an example of ΔL(hr) when aluminum is used for the heating roller 35 will be described. Referring to Table 1, the linear expansion coefficient αa of aluminum is 24×10⁻⁶/° C. Let Δt be a difference in temperature of the heating roller 35 between when the heating roller 35 is cooled and when the heating roller 35 is heated. In this case, ΔL(hr) is as follows.

ΔL(hr)=L(hr)×Δt×αa

TABLE 1
Linear Expansion Coefficient by Material (×10⁻⁶/° C.)

| | |
|---|---|
| Aluminum (5000 series) | 24 |
| Iron | 11 |
| Nickel | 15 |
| Si rubber | 25 to 40 |
| PFA | 120 |
| PI | 54 |

Therefore, when the heating roller 35 is heated from 20° C. to 180° C., the following relationship is established.

ΔL(hr)=L(hr)×(180−20)×24×10⁻⁶

If the linear expansion coefficient is αb, and the difference in temperature of the heating roller 35 between when the heating roller 35 is cooled and when the heating roller 35 is heated is Δt, then the extension amount ΔL(fb) of the fixing belt 34 is as follows.

ΔL(fb)=L(fb)×Δt×αb

When Ni electroforming is used for the fixing belt 34, since the linear expansion coefficient αb is 15×10⁻⁶/° C. from Table 1, ΔL(fb) is as follows.

ΔL(fb)=L(fb)×(180−20)×15×10⁻⁶

As described above, when L(hr) and L(fb) are the same, the extension amount of the heating roller becomes larger.

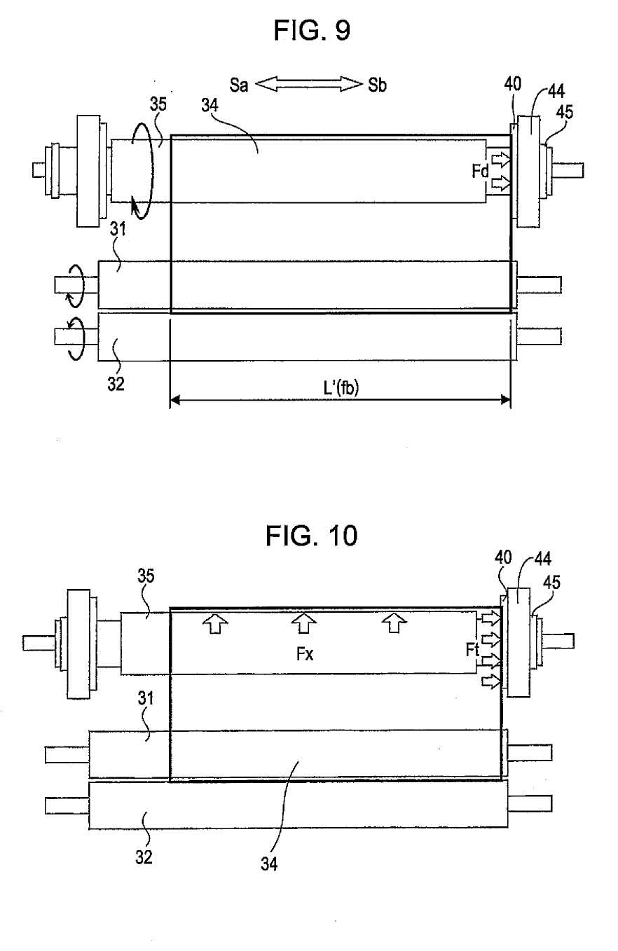

In the belt fixing device, for example, a pair of rollers (in this example, the fixing roller 31 and the heating roller 35 functioning as tension rollers) with the fixing belt 34 stretched therebetween are not in parallel due to a variation in part precision of the fixing frame 41. For this reason, when the tension rollers are rotated, the fixing belt 34 leans in the axial direction of the roller (skewed movement). In FIG. 9, the fixing belt 34 leans in a right direction of the drawing along the axis of the roller. In this case, the same force as the screw rule is applied to the heating roller 35 in contact with the inner surface of the fixing belt 34, and the heating roller 35 leans in a left direction of the drawing along the axis of the roller. Sa denotes the movement direction of the heating roller 35, and Sb denotes the movement direction of the fixing belt 34. As described with reference to FIG. 5, the heating roller 35 is provided in the fixing unit by the bearing 44 so as not to be separated in the axial direction.

The heating roller 35 is configured so as not to move in the axial direction anymore if a snap ring 45, which is provided at the right end of FIG. 9, comes into contact with the bearing 44. For this reason, when the heating roller 35 rotates, stress Fd when the fixing belt 34 tries to move is given to the guide ring 40, which is provided on the right side of the drawing. The guide ring 40 is formed of a material having strength, heat resistance, and slidability. Therefore, the destruction strength of the guide ring 40 and the fixing belt 34 can be increased, and abrasion in an engaging end portion of the fixing belt 34 can be minimized.

Thermal contraction of the fixing belt 34 and the heating roller 35 after printing is completed will be described with reference to FIG. 10. Immediately after the heating roller 35 stops to rotate and the fixing heater is turned off, the fixing belt 34 and the heating roller 35 having been heated start to thermally contact. The timing at which the heating roller 35 stops to rotate and the fixing heater 36 is turned off or the order in which the heating roller 35 stops to rotate and the fixing heater 36 is turned off may be appropriately selected. The heating roller 35 is restrained by the snap ring 45 and the bearing 44 on the right side of FIG. 10, and thermal contraction of the heating roller 35 acts on the restrained portion. The inner surface of the fixing belt 34 and the outer peripheral surface of the heating roller 35 are strongly held by a force Fx=belt tension×stiction force therebetween. In this state, if the heating roller 35 thermally contracts toward the restrained portion, the fixing belt 34 also moves toward the restrained portion in the same manner.

The above-described thermal expansion and contraction of the heating roller 35 are reversible operations. For this reason, when the heating roller 35 and the fixing belt 34 having the same length thermally contract, the contraction amount of the heating roller 35 becomes larger than the contraction amount of the fixing belt 34. A difference in the contraction amount between the heating roller 35 and the fixing belt 34 is given as stress Ft on the right side of FIG. 10, such that the fixing belt 34 bites into the guide ring 40. If stress Ft is repeatedly given, shear destruction occurs in the end portion of the fixing belt 34.

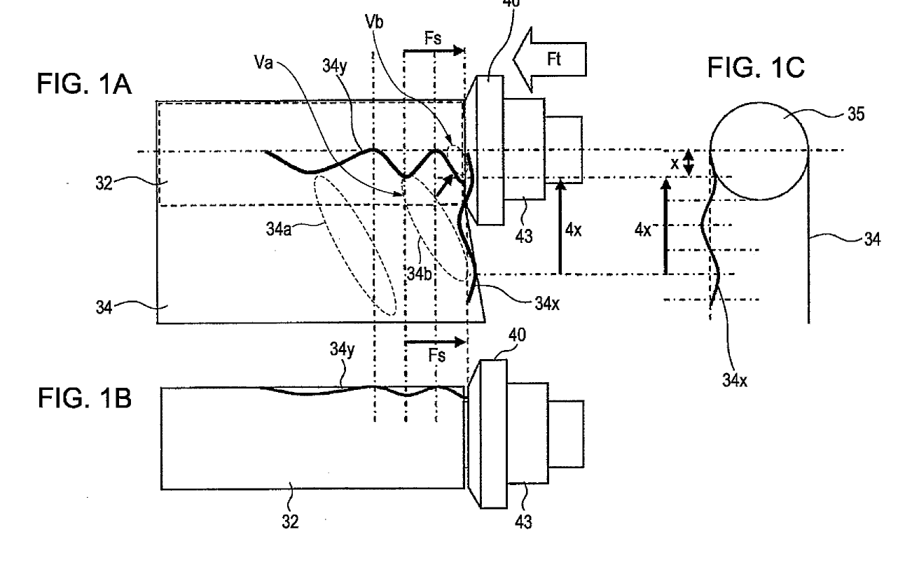

FIGS. 1A-1C illustrate a state before the fixing belt 34 starts to be driven. FIG. 1A is a plan view, FIG. 1B is a front view, and FIG. 1C is a side view of the heating roller 35 when viewed from the axial end. While the fixing belt 34 is not driven, the amount of thermal contraction of the heating roller 35 is larger than the amount of thermal contraction of the fixing belt 34. For this reason, the guide ring 40 presses the end portion of the fixing belt 34 along the axial direction of the heating roller 35 with the force Ft.

Although the fixing belt 34 is pressed in the axial direction of the heating roller 35 by the guide ring 40, it cannot be easily moved due to a frictional force between the fixing belt 34 and the heating roller 35. For this reason, a large stress (reactive force Fs) is applied to the end portion of the fixing belt 34, and accordingly ruffles (wrinkles) 34x and 34y are formed in the fixing belt 34. In FIG. 1A, Vb denotes an end portion bend that is formed in the end portion of the fixing belt 34, and Va denotes a “wrinkle” that is formed near the end portion bend Vb. A plurality of “wrinkles” 34a, 34b . . . are formed in the axial direction of the heating roller 35.

In FIG. 1C, x denotes an x coordinate of a position where the guide ring 40 comes into contact with the fixing belt 34 and hooks the end portion of the fixing belt 34 due to thermal contraction. That is, x corresponds to an end portion bend length of the fixing belt 34 when the guide ring 40 comes into contact with the end portion of the fixing belt 34 and hooks the end portion of the fixing belt 34 due to thermal contraction. A wrinkle (end portion bend) that is formed in the end portion of the fixing belt 34 is generated with the x coordinate as a peak, and subsequent ruffles in the movement direction of the fixing belt 34 are substantially generated at the corresponding cycle, or at least at a pitch longer than the cycle.

In the embodiment of the invention, as described below, when the fixing belt 34 having stopped restarts, forward or backward rotation is executed a predetermined number of times so as to move the fixing belt 34 located at the x coordinate in the rotation direction of the fixing belt 34, thereby eliminating the end portion bend. In the example of FIG. 1C, the fixing belt 34 is moved in the rotation direction by not more than 4x.

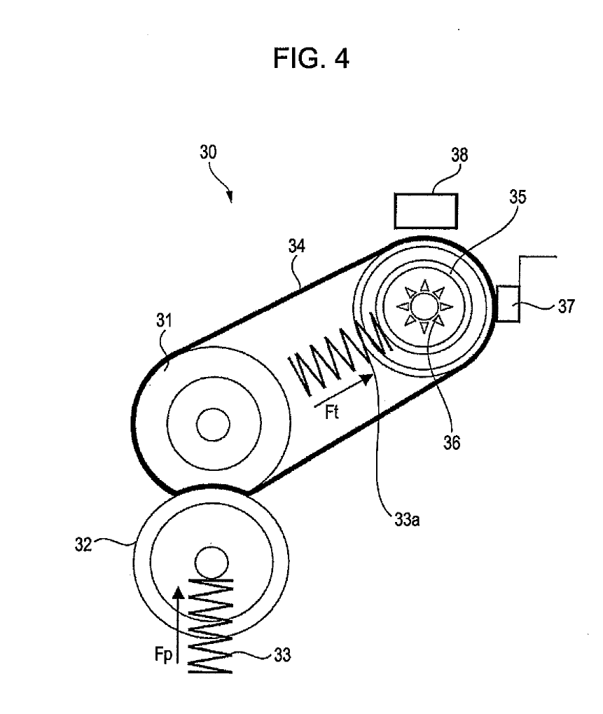

FIG. 2 is an explanatory view illustrating FIG. 1C on magnified scale. FIG. 3 is an explanatory view illustrating the positional relationship between the guide ring 40 and the fixing belt 34 before and after thermal contraction. In FIG. 2, Ta denotes an end portion bend position that is formed in the fixing belt 34 when the guide ring 40 comes into contact with the fixing belt 34 and hooks the end portion of the fixing belt 34 due to thermal contraction. In FIGS. 2 and 3, A denotes a distance (radius) by which the guide ring 40 is in contact with the inner surface of the fixing belt in a state when the fixing belt bites into the guide ring 40 at the time of thermal contraction. If the radius of the heating roller 35 is y, then x is expressed by the following equation.

x=\sqrt{A²−y²} Equation 1

FIG. 3 illustrates the arrangement of members at one axial end of the heating roller 35. A broken line indicates the state before thermal contraction. Reference numeral 43 denotes a heat-insulating bush, and reference numeral 40 denotes a guide ring. A solid line indicates the state after thermal contraction. Reference numeral 43b denotes a heat-insulating bush, and reference numeral 40a denotes a guide ring. The end portion bend position Ta of the fixing belt 34 described with reference to FIG. 2 is at a position Ha before thermal contraction, and is at a position Hb after thermal contraction. The amount Lp of thermal contraction becomes a differential length between Ha and Hb. The amount Lp of thermal contraction may be expressed as follows.

Lp=L(belt width: that is, length in the axial direction)×Δt(control temperature−room temperature)×(linear expansion coefficient of heating roller−linear expansion coefficient of belt)

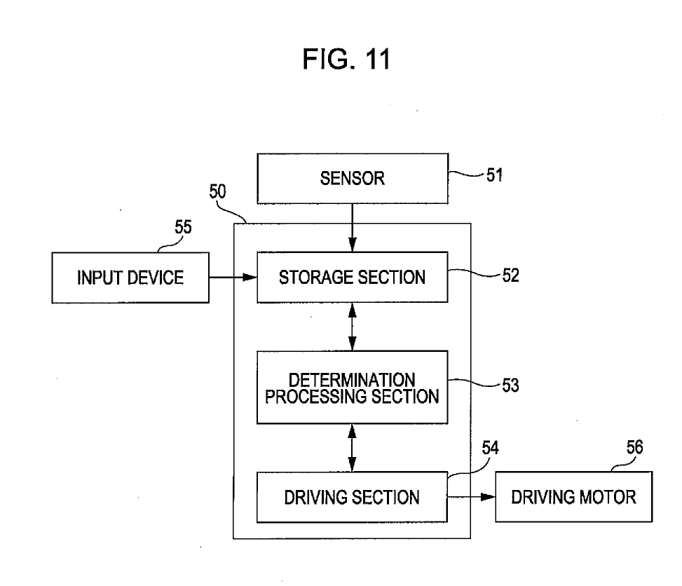

In the embodiment of the invention, a driving unit of the fixing belt is switched between forward rotation and backward rotation. Specifically, a driving motor of the fixing roller 31 described with reference to FIG. 4 controls switching of forward rotation/backward rotation. A storage unit stores temperature data of the fixing belt 34 when the fixing belt 34 has stopped (after the operation ends). The features of this control system are described below with reference to FIG. 11.

In a control method of the fixing belt according to the embodiment of the invention, the timing of repetitive and successive forward or backward rotation of the driving unit of the fixing belt 34 is set as follows: (1) before the fixing belt 34 starts to be driven, when the temperature of the fixing belt 34 is lower than a predetermined temperature (for example, 100° C.); and (2) before the fixing belt 34 starts to be driven, a difference in temperature of the fixing belt 34 between when the fixing belt 34 has stopped and immediately before the fixing belt 34 is driven is equal to or more than a predetermined value (for example, 80° C.). The surface temperature of the fixing belt 34 at the end of the operation is detected by the sensor 48 shown in FIG. 6

The repetitive and successive forward or backward rotation of the driving unit of the fixing belt 34 may be set as follows. (1) The rotation direction when the fixing belt 34 starts to be driven may be forward or backward. (2) While the driving unit of the fixing belt 34 is rotating forward or backward, the heating roller 35 can be heated. (3) If the fixing belt 34 when the driving unit of the fixing belt 34 rotates forward or backward is at high velocity, the acceleration by the inversion operation increases, thereby reducing the wrinkles of the fixing belt 34.

(4) The belt movement amount in the rotation direction when the fixing belt 34 rotates forward or backward becomes equal to or less than 4x in the rotation direction of the fixing belt 34 where x is the x coordinate when the guide ring 40 comes into contact with the fixing belt 34 and hooks the end portion of the fixing belt 34 due to thermal contraction. That is, if the end portion bend length of the fixing belt 34 when the guide ring 40 comes into the contact with the end portion of the fixing belt 34 and hooks the end portion of the fixing belt 34 due to thermal contraction is x, then the belt movement amount is set to be not more than 4x. (5) The end timing of forward or backward rotation of the fixing belt 34 (change to rotation of normal velocity) may be set as follows. a) The forward or backward rotation of the fixing belt 34 is executed a predetermined number of times. The predetermined number of times is determined by μ (coefficient of static friction) between the heating roller 35 and the fixing belt 34, tension of the fixing belt 34, a velocity of the fixing belt 34 when the fixing belt 34 is switched to forward or backward rotation, and the like. b) The forward or backward rotation of the fixing belt 34 is executed a predetermined number of times on the basis of the difference in temperature of the fixing belt 34 between when the fixing belt 34 has stopped and when the fixing belt 34 starts to operate. The predetermined number of times is set in the storage unit in the form of table, and control is performed on the basis of the table read from the storage unit.

As described above, according to the embodiment of the invention, if the belt movement amount is set, two ruffles (end portion bend and adjacent wrinkle) generated in the end portion of the fixing belt 34 can be prevented from being connected when the fixing belt 34 is driven again and becoming a crack. In addition, if the fixing belt 34 is inversely moved, the frictional force between the fixing belt 34 and the heating roller 35 is reduced from static friction to dynamic friction, and thus the wrinkles formed in the fixing belt 34 can be eliminated.

FIG. 11 is a block diagram illustrating a control device 50 of the belt fixing device that has a sensor 51, a storage section 52, a determination processing section 53, and a driving section 54. An input device 55 inputs, for example, the length in the axial direction of the fixing belt 34 or the heating roller 35. In addition, information such as a coefficient of static friction between the heating roller 35 and the fixing belt 34, tension of the fixing belt 34, an inversion velocity of the fixing belt 34 at the time of forward or backward rotation, and the like, is input. Input information from the input device 55 is stored in the storage section 52.

The sensor 51 detects the temperature of the fixing belt 34, and the measurement value is stored in the storage section 52. The sensor 51 corresponds to the temperature detection device 37 for turning on/off the fixing heater 36 of the heating roller 35 described with reference to FIG. 6, and the sensor 48 detecting the temperature of the fixing belt 34 when the fixing belt 34 has stopped. The sensor 48 detecting the temperature of the fixing belt 34 detects the temperature with various timings when the fixing belt 34 has stopped, such as the temperature of the fixing belt 34 at the end of the operation, the temperature of the fixing belt 34 immediately before the fixing belt 34 restarts to operate.

The determination processing section 53 forms a forward/backward rotation control signal of a driving motor 56 of the fixing belt 34 on the basis of the temperature of the fixing belt 34 at the time of stoppage stored in the storage section 52, and sends the control signal to the driving section 54. The driving section 54 controls the driving motor 56 in accordance with the control signal. The sensor 51, the storage section 52, the determination processing section 53, and the driving section 54 are preferably in the belt fixing device or the image forming apparatus. The input device 55 may be connected to the belt fixing device or the image forming apparatus when input information is input to the belt fixing device or the image forming apparatus.

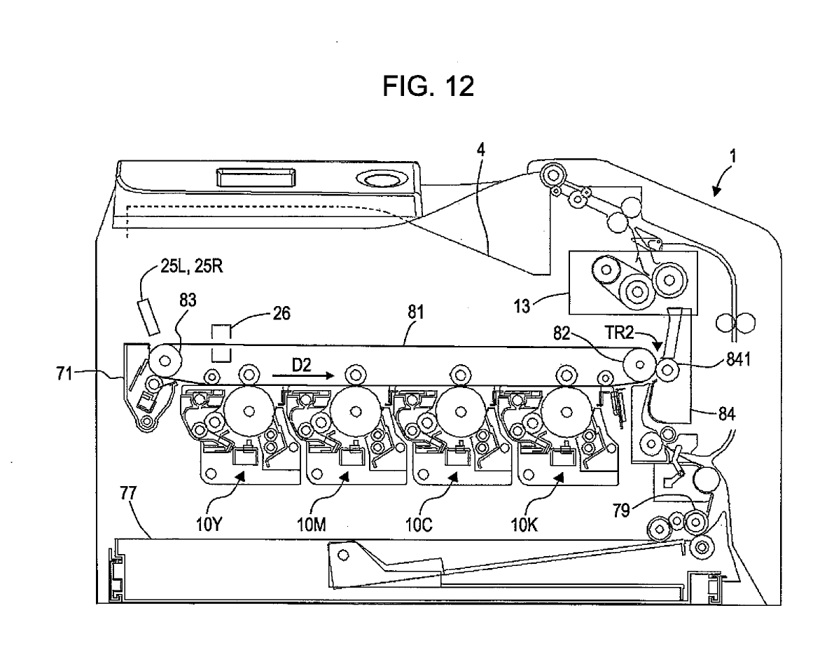

FIG. 12 is a side sectional view illustrating an example of a tandem type color image forming apparatus according to the embodiment of the invention. An image forming apparatus 1 forms a color image by combining toner of four colors, for example, black (K), cyan (C), magenta (M), and yellow (Y), or forms a monochrome image only using toner of black (K). Four image forming stations 10Y, 10M, 10C, and 10K are arranged along an intermediate transfer belt 81, which is wound around rollers 82 and 83 and revolves in a predetermined direction D2. The image forming stations 10Y, 10M, 10C, and 10K individually store toner of yellow, magenta, cyan, and black, and form monochrome toner images of respective colors.

When a color image is formed, the monochrome toner images of the respective colors formed by the image forming stations are combined with each other on the intermediate transfer belt 81, thereby forming a color image on the intermediate transfer belt 81. A recording sheet, such as paper or a transparent sheet, is taken out from a sheet feeding cassette 77 one by one in accordance with rotation of a sheet feed roller 79, and is transported to a secondary transfer region TR2, which is a nip portion between a secondary transfer roller 841 and the intermediate transfer belt 81. In this manner, the color image formed on the intermediate transfer belt 81 is transferred to a recording medium in the secondary transfer region TR2. The recording medium with an image transferred thereto passes through a fixing unit 13, and is discharged to a sheet discharging tray 4 in the upper portion of the image forming apparatus.

The secondary transfer roller 841 is rotatably mounted in a roller support arm 84. As occasion demands, the arm 84 pivots around a predetermined pivot shaft, and the secondary transfer roller 841 is separated from or comes into contact with the surface of the intermediate transfer belt 81. A vertical synchronization sensor 26 is provided near the roller 83 to detect the rotational phase of the intermediate transfer belt 81. The vertical synchronization sensor 26 is, for example, a photo interrupter, and detects passing of a protrusion or a cutout (not shown) provided in a portion of an edge portion of the intermediate transfer belt 81. That is, the vertical synchronization sensor 26 outputs a vertical synchronizing signal Vsync that is synchronized with the rotation cycle of the intermediate transfer belt 81.

Two position detection sensors 25L and 25R are disposed toward the surface of the intermediate transfer belt 81 wound around the roller 83 at different positions in the axial direction of the roller 83 (a direction perpendicular to the paper). The position detection sensor 25 is, for example, a reflection type photosensor, and detects the presence/absence of passing of a toner image carried on the intermediate transfer belt 81 on the basis of a change in reflectance of the surface of the intermediate transfer belt 81 at a position opposite the intermediate transfer belt 81. A cleaner 71 is provided on the downstream side of the position detection sensors 25L and 25R in the movement direction of the intermediate transfer belt 81. The cleaner 71 cleans and removes residual toner stuck to the intermediate transfer belt 81. Although an example of a tandem type image forming apparatus according to the embodiment of the invention is illustrated, the invention may also be applied to a rotary type image forming apparatus.

Although particular embodiments of the invention have been described, the invention is not limited to these embodiments. Various modifications may be made and are within the scope of the invention as defined by the following claims.

What is claimed is:

1. A method of controlling a belt fixing device, in which a fixing belt is stretched between a fixing roller and a heating roller, the method comprising:
detecting a temperature of the fixing belt at a time of stoppage; and
on the basis of a detection result, rotating a driving unit forward or backward a predetermined number of times when the fixing belt having stopped is driven again.

2. The method according to claim 1, wherein the predetermined number of times of forward or backward rotation is selected depending on one of a coefficient of static friction between the heating roller and the fixing belt, tension of the fixing belt, and an inversion velocity of the fixing belt at the time of forward or backward rotation.

3. The method according to claim 2, wherein if an end portion bend length of the fixing belt when a unit preventing skewed movement of the fixing belt toward an axial end of the heating roller comes into contact with an end portion of the fixing belt and hooks the end portion of the fixing belt due to thermal contraction is x, then a travel distance of the fixing belt in a rotation direction when the driving unit of the fixing belt rotates forward or backward is set to be not more than 4x.

4. The method according to claim 1, wherein when the temperature of the fixing belt at the time of stoppage reaches a predetermined temperature, or when a difference between the temperature of the fixing belt at the time of stoppage and a temperature of the fixing belt immediately before being driven becomes a predetermined value, the driving unit of the fixing belt is rotated forward or backward a predetermined number of times.

5. A belt fixing device comprising:
a fixing roller;
a heating roller;
a fixing belt stretched between the fixing roller and the heating roller; and
a pressing roller pressing the fixing roller through the fixing belt,
wherein in at least one end portion of the heating roller in an axial direction, a ring regulating skewed movement of the fixing belt toward an axial end, and a temperature detection unit detecting a temperature of the fixing belt at a time of stoppage are provided, and
the temperature detected by the temperature detection unit is stored in a storage unit, and a control unit controls forward or backward rotation of a driving unit a predetermined number of times on a basis of the temperature of the fixing belt at the time of stoppage stored in the storage unit when the fixing belt is driven again.

6. The belt fixing device according to claim 5, wherein the temperature detection unit detects a temperature of the fixing belt at an end of the operation and a temperature of the fixing belt immediately before being driven again, and stores the detection results in the storage unit.

7. An image forming apparatus comprising:
image forming units each having at least one of a charging unit, an exposure unit, a developing unit, and a transfer unit around a photosensitive member; and
a belt fixing device that is controlled by the control method according to claim 1,
wherein the image forming apparatus transfers an image formed on each of the image forming units to a recording medium, thereby performing image formation.

8. An image forming apparatus comprising:
image forming units each having at least one of a charging unit, an exposure unit, a developing unit, and a transfer unit around a photosensitive member; and
the belt fixing device according to claim 5,
wherein the image forming apparatus transfers an image formed on each of the image forming units to a recording medium, thereby performing image formation.
